(19) United States
(12) Patent Application Publication
(10) Pub. No.: US 2012/0180229 A1
(43) Pub. Date: Jul. 19, 2012

(54) METHOD FOR ENZYMATIC TREATMENT OF CELLULOSE-CONTAINING TEXTILES BY MEANS OF A SOLUTION THAT COMPRISES AT LEAST ONE CELLULASE TYPE

(75) Inventors: Thomas Bechtold, Dornbirn (AT); Christian Schimper, Koblach (AT)

(73) Assignee: UNIVERSITAET INNSBRUCK, Innsbruck (AT)

(21) Appl. No.: 13/386,013

(22) PCT Filed: Jul. 15, 2010
(86) PCT No.: PCT/EP2010/060238

§ 371 Date: Apr. 2, 2012

(30) Foreign Application Priority Data
Jul. 24, 2009 (EP) 09009606.6

(51) Int. Cl. C12S 11/00

(52) U.S. Cl. 8/188; 8/194; 8/189; 8/195

(57) ABSTRACT

A method for enzymatic treatment of cellulose-containing textiles by means of a solution that comprises at least one cellulase type, characterized in that before the treatment with the cellulase-containing solution, an aqueous solution having a pH below 7 and containing at least one agent raising the swelling capacity of the solution, preferably a neutral salt solution, is applied to only some areas of the textile.

The present invention relates to a method for enzymatic treatment of cellulose-containing textiles by means of a solution that comprises at least one type of cellulase.

Enzymatic processes have been widely used in the treatment of textile substrates. In recent years, cellulose-cleaving enzymes (cellulases) have gained great importance in the textile-chemical treatment of materials containing cellulose fibers. The technically most frequently used “total crude” cellulases are a mixture of microbiologically produced endo-, exocellulases and cellobiohydrolases. The task of the cellulases is to hydrolytically degrade cellulose by selective cleavage of the β-1,4-glycosidic bond, so that soluble debris is removed from the polymers and taken up by the treatment solution, where further hydrolysis to glucose takes place. Usually, this is done to change the hand of materials, remove lint, and improve undesired tendency to pilling of materials. A special field of application is during washing of indigo-dyed denim textiles, where enzymatic treatment is used in place of or in addition to a bleaching treatment. Here, enzymes allow the so-called wash-down, which leads to the used look of jeans after the washing process of finished textiles.

Furthermore, treating cellulose-containing fibers with an alkaline cellulose solution is known from the state of the art, since the rate of degradation of cellulose is higher in alkaline media than in the neutral pH range. Finally, it is known to add a swelling agent to cotton fibers before cellulase treatment in order to reduce enzymatic degradation in the area that takes up the swelling agent.

In all processes, the textiles are exposed to cellulase treatments in large-scale washing machines, which treatments weaken the textile through hydrolytic attack and thus support, in combination with the washing mechanics, wear of any dyes present, which leads to the development of wash-down. Cellulase treatments always lead to a loss of mechanical resistance of the textile, which leads to reduced strength and lower abrasion resistance of treated products compared to non-treated products. This reduction of the use-value is an undesired result of cellulase treatment.

One solution of the problem is mentioned in EP 2 000 583 A1, where before the actual treatment of the cellulosic materials with cellulases, a targeted local activation of the fiber materials is conducted with preparations that contain concentrated alkaline-reactive substances. This may lead to better degradation performance of the cellulose-cleaving enzymes in the treated areas without, for example, any disadvantageous effects on the yarn areas responsible for strength that are located in the interior of the material.

However, the working method proposed in EP 2 000 583 A1 has several disadvantages resulting from the use of concentrated alkaline preparations:
From the point of view of industrial hygiene, handling of concentrated alkaline solutions involves a considerable risk potential. Consequently, corresponding extensive measures for guaranteeing occupational safety are required to guarantee safe handling.
Intermediate storage of treated materials stably over time is not possible because carbon dioxide taken up from the air results in partial neutralization, which may change the effect of the applied base in an indefinable and locally diverse way.
Before the actual enzyme treatment, careful neutralization of the solutions and the treated goods is required because uncontrolled carry-over of caustic soda into cellulase treatment baths may affect or possibly even stop the effect thereof. In that case, large amounts of buffer substances have to be used to safely intercept possible carry-over of caustic soda.
The necessary intermediate washing requires large amounts of water, which leads to additional costs for fresh and waste water.

Thus, it is an object of the present invention to provide a method of the type mentioned above, wherein the textile shows only imperceptible loss of mechanical strength, and which overcomes the disadvantages mentioned with regard to EP 2 000 583 A1.

This object is achieved with a method according to claim 1. Such a method of the type mentioned above is characterized in that, before treatment with a cellulase-containing solution, an aqueous solution having a pH below 7 and containing at least one agent raising the swelling capacity of the solution, preferably a neutral salt solution, is applied to only some areas of the textile.

The method is based on the finding that the efficacy of cellulase on a cellulose-containing textile is increased when the textile is pretreated in the area to be treated with an aqueous solution having a pH below 7 and containing an agent raising the swelling capacity. A swelling agent is an agent capable of at least locally penetrating the cellulose structure and thus effecting an increase of the cellulose structure volume. The swelling agent thus leads to a volume increase and usually also to a significant change in the physical properties, e.g. fiber strength, flexibility, elasticity etc. Regarding the physicochemical state, interactions between the macromolecules and the swelling agent are more favorable that intermolecular forces between the macromolecules on the one hand and the swelling agent molecules on the other hand. The at least partial penetration of the swelling agent into the polymeric structure (and thus the increase in volume) is thus energetically favored (Source: D. Klemm, B. Philipp, T. Heinze, U. Heinze, W. Wagenknecht, Comprehensive Cellulose Chemistry, Vol. I and II, Wiley-VCH, 1998, ISBN 3-527-29413-9, Vol. 1, p. 43, Chapter 2.2 Swelling and Dissolution of Cellulose).

With swelling agents, the diphase structure (cellulose in swollen state) and the liquid phase are maintained. On the contrary, solvents, which are able to dissolve the polymer, lead to a homogeneous monophase solution of the macromolecular matter as the stable final state.

According to DIN 60 000, textiles comprise textile fibers, textile semifinished and finished articles, e.g. yarns or fabrics, and textile finished goods such as textile clothing etc. It is substantial for the invention that the textile contains cellulose (e.g. blended fabrics)—however, the textile does not have to consist thereof.

Such a method may provide for pretreatment of the textile (e.g. the textile fiber) at the surface with a swelling agent in a way that the agent only slightly penetrates the textile or textile fiber. For this purpose, it may be envisaged that, before treatment with the cellulase-containing solution, the aqueous solution, preferably a neutral salt solution, is applied to the surface of the textile fiber or the textile in a way that it essentially remains at the surface of the textile. “Essentially remains at the surface of the textile” means that the swelling-inducing agent cannot penetrate to the core of the textile fiber or textile, but penetrates the textile fiber less than 20 to 30% of the thickness of the textile fiber, preferably less than 10% of the thickness of the textile fiber.

This is especially achieved by applying the treatment solution, i.e. the aqueous solution with pH<7 comprising an agent that raises the swelling capacity, is applied by spraying and/or slop-padding and/or knife coating and/or printing.

Preferably it is envisaged that the textile fiber or a sheet textile obtained from a textile fiber, e.g. a fabric, is provided with patterns that may, on the one hand, have different colors (“stone-wash effect”), and on the other hand a more pleasant or different hand. In case the textile fiber is a sheet textile, preferably a fabric, individual given patterns may be applied to the textile, especially by printing a given print pattern. It may be envisaged that the swelling-inducing agent is applied on only one side on at least a part of the sheet textile. Especially with functional textiles, different treatments of the two sides of a sheet textile, preferably a fabric, are of interest in order to achieve advantages with regard to functional properties (water transport, absorption, smoothness etc.).

The invention is based on that in the areas in which a non-alkaline swelling agent, preferably a neutral salt solution, has been applied, a higher degradation rate may be achieved because the cellulase has a higher reaction rate in these areas.

Neutral swelling solutions may especially be liquids from the classes of ionic liquids (e.g. 1-n-butyl-3-methylimidazolium chloride, 1-allyl-3-methylimidazolium chloride or homologous substances and corresponding acetates), of organic swelling agents (e.g. N-methylmorpholine-N-oxide), of inorganic salts (e.g. CaCl₂, ZnCl₂, LiCl, NaSCN, MgCl₂), and more complex mixtures such as LiCl/N,N-dimethylacetamide, NH₄Cl—sym-dimethylurea, NaCl/urea, preferably concentrated solutions of ecologically safe substances such as CaCl₂, NaCl/urea, which may lead to ecological advantages and cost benefits in addition to their safety. Especially advantageous are mixtures that only slightly affect the functioning of the enzymes, the solutions mentioned above of CaCl₂ or NaCl/urea being especially advantageous.

The reaction rate between fiber-enzyme depends on the fiber type used (cotton, viscose fibers, lyocell fibers etc.) as well as the concentration and activity of the enzyme used. Depending on the processing step of the finishing process, the fiber changes with regard to its reactivity.

To select conditions appropriate for the corresponding textile fiber type to meet the above requirements, it may be favorable if the swelling-inducing agent comprises a thickening agent. In order to support the progress of the reaction, it may also be favorable if the treatment solution comprises a moisturizer, wherein it is especially preferable that the moisturizer comprises glycerol. Often, the treatment conditions mentioned are hygroscopic, in which case the addition of an additional moisturizer is usually not necessary.

The treatment of cellulosic substrates in solutions of various swelling-inducing agents has been studied extensively because of the possibility to change the reactivity of cellulose. Alkaline treatment solutions known in the art may contain alkali ions (Li, Na, K ions), but, for example, alkaline earth hydroxides and quaternary ammonium hydroxide are also known. The treatment in solvent systems (alcoholic solutions of swelling agents) has also been described in the state of the art. Other swelling-inducing substances may come from the classes of ionic liquids, organic matters (NMMO, N-methylmorpholine-N-oxide), concentrated inorganic salt solutions (CaCl₂, ZnCl₂, LiCl, NaSCN, MgCl₂), and more complex mixtures such as LiCl/N,N-dimethylacetamide, NH₄Cl—sym-dimethylurea, NaCl/urea. Swelling agents with strong acid reactivity, such as orthophosphoric acid and polyphosphoric acid, have also been described as swelling agents.

Consequently, the present invention is based on the idea to activate fibers only locally and to thus limit the rate of hydrolytic degradation of cellulose to certain areas of a textile structure.

This is achieved by limiting the effect of the activating swelling treatment to certain areas of a material. This may, for example, be at the surface of the textile structure by applying the amount of swelling agent in a way that only the outermost structure is activated for the cellulase attack. Surprisingly, this may cause a strong surface activation which may lead to a hydrolytic effect of the enzymes that is mainly limited to the surface.

Application of the activating swelling-agent solution may be effected by means of common methods of spraying, slop-padding, knife coating, and minimum application techniques on one or both sides of the goods, wherein in an especially preferred embodiment, printing techniques (screen printing, foam printing) are to be mentioned. This allows a one-sided surface activation of cellulose as well as the implementation of a patterning effect.

The advantages of the present method over EP 2 000 583 A1 are especially apparent when looking at the application types because by using non-caustic conditions, the safety-related restrictions are largely suspended.

Swelling agents may come from the classes of ionic liquids, organic matters (NMMO, N-methylmorpholine-N-oxide), concentrated inorganic salt solutions (CaCl₂, ZnCl₂, LiCl, NaSCN, MgCl₂), and more complex mixtures, such as LiCl/N,N-dimethylacetamide, NH₄Cl—sym-dimethylurea, NaCl/urea, or be other cellulose swelling agents known to an average skilled person.

Advantageous concentrations of application solutions are in the range of 0.5 M to saturated solutions, wherein the concentration is determined by the activation effect desired, the textile substrate to be treated, and an optional intermediate drying step. In the intermediate drying step, the non-volatile portion of the swelling-agent preparation is reconcentrated at the surface so that a higher concentration than in the application solution applied is achieved. Based on the invention, the optimum concentration range for a desired result can also readily be determined by the average skilled person by means of serial experiments.

In an advantageous embodiment, moisturizers, such as glycerol, are added to the solution before application in order to prevent complete drying and solidification.

Textile structures may, for example, be woven fabrics, knitted fabrics, fleeces, sheets etc., wherein the form of the material to be treated is not limited. Cellulosic substrates may preferably be made of cotton, bast fibers, viscose, modal fibers, lyocell fibers or mixtures thereof with other fibers of cellulose or other fiber materials, especially synthetic materials. In a preferred type, dyed textiles of cotton or other cellulose fibers or mixtures thereof with synthetic fibers (e.g. lycra, polyester fibers, polyamide) are treated, wherein in an especially preferred embodiment, indigo-dyed denim fabrics of cellulose fibers are treated.

Appropriate cellulase treatment methods can be selected from the methods proposed in the state of the art.

The local activation leads to an accelerated hydrolysis of the cellulose in the activated areas. If the treatment is effected at the surface, it is mainly the surface that is hydrolytically attacked by the cellulases, and the strength and mechanical resistance of the material in the core of the textile structure is affected less. In an especially preferred treatment method, denim fabric ring-dyed with indigo is activated, which has the advantage that the indigo dye is rapidly detached from the fabric surface. Thus, the time of washing processes of denim may be advantageously reduced, and when the activation follows predetermined patterns, special patterning effects and designs can be implemented.

The use of neutral activation conditions, which is advantageous over EP 2 000 583 A1 and, even when present in the enzyme treatment bath, in many cases does not have disadvantageous impacts on the functioning of the enzymes, reduces the time required for washing out the treatment chemicals before the actual enzyme treatment, which saves process time, costs and water/waste water.

Suitably, it may be further envisioned that after application of the swelling-agent solution and before cellulase treatment, a drying step is conducted, especially by heating the textile.

The preferred embodiment envisions that the textile is dyed in at least some areas, preferably indigo-dyed, wherein especially preferably the textile comprises textile fibers woven into a fabric, preferably a denim fabric, or the swelling substance is applied to ready-made finished textiles before washing treatment.

Further details of the invention are described with reference to the following examples.

### Test Procedure with the Denim Example

### Pretreatment:

Specimens (denim, 10×15 cm, approx. 7.5 g, 500 g/m²) are treated with the test solution. Application is effected at the surface, in this case by dabbing with a sponge.

One pattern is treated with the soft side of the sponge (A), another one with the rough side of the sponge (B). The exposure time to the chemicals is 30 minutes.

Then, the specimen is pressed through the squeezer of a Foulard (5 bar, 2 m/min), causing the chemicals to penetrate far into the interior of the fabric.

One specimen is immediately rinsed, a second part is dried at 60° C. for 5 min and then rinsed, each one for approx. 5 min under running water. No intermediate drying is conducted before the enzyme treatment.

Enzyme treatment:

The wet specimens are individually introduced into approx. 200 mL of treatment solution (liquor ratio 1:25, pH 4.6 Na-acetate buffer, 30 mL/L Primafast 100 (cellulase preparation)) and treated therein for 60 min at 55° C. (heating gradient 2°/min) in a laboratory dying apparatus (Labomat). The bath is immediately removed, refilled with soft water, and the solution is alkalized in order to stop the enzyme activity. This treatment is done for 10 min at 75° C. (heating gradient 5°/min) in the laboratory dying apparatus. Then, the specimens are extensively washed in water and dried. The characterization of color changes was done by measuring the color coordinates as CIELab values.

The effectiveness of the treatment of the activated areas was confirmed by comparative specimens: A non-activated comparative specimen was enzyme-treated, and specimens treated with activation solutions were treated without addition of cellulase, in order to detect a possible color change due to the activation chemicals used.

Table 1 compares the results of the untreated and the activated fabrics. The lighter color is easily recognizable through the increased degradation at the surface of the materials. The overall color difference ΔE has also been calculated and is shown. ΔE values above 10 clearly show the increased loss of color in the pretreated areas. (In practice, ΔE values below 1 are classified as non-determinable, non-visible differences, a person skilled in the art classifies such differences as undistinguishable color differences).

TABLE 1

| | | Sponge (A) | | Sponge (B) | |
|---|---|---|---|---|---|
| Material | Treatment | L* | ΔE | L* | ΔE |
| | with enzyme: | | | | |
| 0 | not activated | 27.09 | 0.0 | — | — |
| I | 4M NaSCN + 2M CaCl₂ (2M Ca(SCN)₂) | 29.59 | 2.43 | 36.42 | 8.43 |
| II | 4M NaSCN + 2M CaCl₂ (2M Ca(SCN)₂) | 31.03 | 3.89 | 33.28 | 5.70 |
| III | 50 g CaCl₂ + 50 g ZnCl₂ in 50 g H₂O | 32.37 | 3.24 | 33.35 | 6.00 |
| IV | 50 g CaCl₂ + 50 g ZnCl₂ in 50 g H₂O | 38.37 | 10.19 | 40.22 | 11.83 |
| V | 0.26M DMDHEU + 0.14M MgCl₂ in | 30.59 | 3.21 | 33.96 | 6.16 |
| | 50 g H₂O | | | | |
| VI | 0.26M DMDHEU + 0.14M MgCl₂ in | 31.05 | 3.79 | 35.96 | 7.80 |
| | 50 g H₂O | | | | |
| VII | 40 g ZnCl₂ + 40 g MgCl₂ + 10 g urea in | 29.78 | 2.78 | 30.21 | 3.24 |
| | 50 g H₂O | | | | |
| VIII | 40 g ZnCl₂ + 40 g MgCl₂ + 10 g urea in | 29.51 | 2.18 | 31.55 | 4.32 |
| | 50 g H₂O | | | | |
| IX | 40 g CaCl₂ + 50 g HCOOH in 50 g H₂O | 30.69 | 3.51 | 31.47 | 4.24 |
| | without enzyme: | | | | |
| o0 | not activated | 25.22 | 0.0 | — | — |
| oI | 4M NaSCN + 2M CaCl₂ (2M Ca(SCN)₂) | 24.60 | −0.71 | 26.25 | 0.98 |
| oII | 4M NaSCN + 2M CaCl₂ (2M Ca(SCN)₂) | 25.90 | 0.86 | 25.86 | 0.56 |
| oIII | 50 g CaCl₂ + 50 g ZnCl₂ in 50 g H₂O | 24.98 | −0.20 | 24.88 | −0.19 |
| oIV | 50 g CaCl₂ + 50 g ZnCl₂ in 50 g H₂O | 24.64 | −0.74 | 26.21 | 0.44 |
| oV | 0.26M DMDHEU + 0.14M MgCl₂ in | 24.27 | −0.90 | 24.94 | −0.46 |
| | 50 g H₂O | | | | |
| oVI | 0.26M DMDHEU + 0.14M MgCl₂ in | 25.02 | −0.34 | 26.04 | 0.77 |
| | 50 g H₂O | | | | |
| oVII | 40 g ZnCl₂ + 40 g MgCl₂ + 10 g urea in | 26.26 | 1.03 | 24.41 | −0.60 |
| | 50 g H₂O | | | | |
| oVIII | 40 g ZnCl₂ + 40 g MgCl₂ + 10 g urea in | 25.23 | 0.02 | 24.34 | −0.67 |
| | 50 g H₂O | | | | |
| oIX | 40 g CaCl₂ + 50 g HCOOH in 50 g H₂O | 25.18 | 0.12 | 25.41 | −0.58 |

DMDHEU = dimethyl dihydroxy ethylene urea
Color coordinates of specimens after cellulase treatment with (Specimens I-IX) and without (Specimen 0) previous activation treatment with a substance that increases swelling capacity, as well as comparative specimens without the addition of enzymes (Specimens o0-oIX) (L* = lightness (0 = black, 100 = white)a* = red-green (−value = green, +value = red) b* = yellow-blue (−value = blue, +value = yellow) and ΔE represent the CIELab coordinates or the corresponding color difference. The CIE Lab System is a color space that was defined by the International Commission on Illumination (Commission Internationale d'Eclairage, CIE) in 1976.

1-15. (canceled)

16. A method for enzymatic treatment of cellulose-containing textiles by means of a solution that comprises at least one cellulase type, wherein before treatment with the cellulase-containing solution, an aqueous solution having a pH below 7 and containing at least one agent raising the swelling capacity of the solution is applied to only some areas of the textile.

17. The method according to claim 16 wherein before treatment with the cellulase-containing solution, the aqueous solution is applied to the surface of the textile in a way that it essentially remains at the surface of the textile.

18. The method according to claim 16 wherein the textile is provided in sheet form.

19. The method according to claim 18 wherein the aqueous solution is applied at only one side and on at least a part of the sheet textile.

20. The method according to claim 16 wherein the agent is selected from the group of ionic liquids, inorganic swelling agents, inorganic salts, or mixtures thereof.

21. The method according to claim 20 wherein the agent is selected from the group of 1-n-butyl-3-methylimidazolium chloride, 1-allyl-3-methylimidazolium chloride, homologous substances or corresponding acetates, N-methylmorpholine-N-oxide, CaCl₂, ZnCl₂, LiCl, NaSCN, MgCl₂, LiCl/N,N-dimethylacetamide, NH₄Cl—sym-dimethylurea, NaCl/urea, or mixtures thereof.

22. The method according to claim 16 wherein the aqueous solution is applied to the textile by spraying, slop-padding, knife coating, printing, or a combination thereof.

23. The method according to claim 16 wherein the aqueous solution comprises a thickening agent.

24. The method according to claim 16 wherein the aqueous solution comprises a moisturizer.

25. The method according to claim 24 wherein the moisturizer comprises glycerol.

26. The method according to claim 16 wherein after application of the aqueous solution and before cellulase treatment, a drying step is conducted.

27. The method according to claim 16 wherein the textile is dyed in at least some areas.

28. The method according to claim 16 wherein the textile comprises textile fibers woven into a fabric.

29. The method according to claim 16 wherein the treatment with an aqueous solution is conducted on ready-made finished textiles before a washing treatment.

30. The method according to claim 16 wherein the fabric is rinsed before the cellulase treatment.

31. The method according to claim 16 wherein said aqueous solution is a neutral salt solution.

32. The method according to claim 26 wherein said drying step is conducted by heating the textile.

33. The method according to claim 27 wherein said textile is indigo-dyed.

34. The method according to claim 28 wherein said fabric comprises a denim fabric.
